(19) United States
(12) Patent Application Publication
(10) Pub. No.: US 2004/0169167 A1
(43) Pub. Date: Sep. 2, 2004

(54) Mobile engine lift apparatus

(76) Inventors: Hal Reinelt, Maple Ridge (CA); Frank Roblin, Mission (CA)

Correspondence Address: DONALD V. TOMKINS, C/O MILLER THOMSON LLP, 2700, 10155 - 102 STREET, EDMONTON, AB, T5J 4G8, CA

(21) Appl. No.: 10/374,422

(22) Filed: Feb. 27, 2003

(51) Int. Cl. B66F 3/00

(52) U.S. Cl. 254/7 B

(57) ABSTRACT

A mobile engine lift apparatus has a base, an extendible vertical support, and pivotable cradle means for lifting, supporting and transporting a motorcycle engine. The apparatus may be rolled into position with the cradle means adjacent a motorcycle engine. Extension means may be engaged to raise the cradle means, thereby lifting the engine away from the motorcycle. The cradle means may be adjusted to a desired position to permit careful removal and replacement of a motorcycle engine without causing damage to the motorcycle or the engine. The apparatus permits lifting and movement of an engine by a single individual in a safe manner. The engine, supported by the cradle means, may then be moved to a preferred location for transfer to a servicing location. The engine may be serviced while supported in the apparatus, or it may be removed from the apparatus for servicing.

### TECHNICAL FIELD OF THE INVENTION

The present invention relates generally to apparatus for lifting equipment components, and relates in particular to apparatus for lifting and transporting motorcycle engines.

### BACKGROUND OF THE INVENTION

Motorcycle engine servicing, testing, and repair demand clear access by the mechanic to the engine being serviced. Gaining access to a motorcycle engine for servicing generally requires removal of the engine from the motorcycle, placement of the engine in a stable lift, and transport of the engine to a testing or repair location.

Owing to the size, weight and shape of some motorcycle engines, lifting and removal to a repair location is not easily accomplished without mechanical assistance or additional workers. In addition, removal of a heavy, awkward engine may result in costly damage to the motorcycle or to the engine itself if not done carefully.

It is known to provide a device for lifting an engine. An example of such a device for a car engine can be seen in Canadian Patent No. 1,045,107 to Bontrager. The Bontrager patent discloses a support frame designed to rest on opposing sides of the vehicle from which the engine is being removed.

For lifting and removal of a motorcycle engine, a support frame independent of the vehicle frame is preferable. Examples of such a device include U.S. Pat. No. 6,003,830 to Egan, U.S. Pat. No. 4,848,717 to Bevill, and U.S. Pat. No. 4,932,628 to Pacheco. In each of the Egan, Bevill and Pacheco patents, a portable engine stand is provided, but no means are described for removal of the engine from a motorcycle and replacement of the engine in the motorcycle.

There are a number of desirable objectives in relation to a mobile engine lift apparatus. Such apparatus should ideally provide a support base broad enough to distribute the engine's weight while maintaining stability, plus rolling means for ease of moving the apparatus from place to place. Such apparatus should also provide cradle means to hold a motorcycle engine in place once it is removed from the motorcycle. Preferably, the cradle means would be pivotable, thus providing adjustability for optimal configuration of the cradle means to accommodate irregularly-shaped items such as motorcycle engines. The cradle means preferably should comprise cradles with adjustable cradle separation means, whereby the space between the cradles can be varied, further enhancing the ability to configure the cradle means to accommodate engines of differing sizes. The apparatus should be easily operable by a single person, and should preferably be adjustable in height to accommodate engines of various mounting heights.

Existing engine lifts achieve some of these objectives, but with varying degrees of success. For example, the devices in Egan and Pacheco comprise multiple vertical supports and elevated horizontal cross-bars which restrict movement of these devices. None of the mentioned prior art devices provide cradle means for supporting of the engine during each of removal, transfer and replacement. Further, none of these prior art devices provide pivotable cradle means.

It is an object of the present invention to provide a mobile engine lift apparatus operable by one individual, which is easily adjustable to permit safe removal and replacement of a motorcycle engine without harm to the engine, the motorcycle or the individual. It is a further object to provide such a mobile lift apparatus which can also be advantageously used for removal and replacement of equipment components other than motorcycle engines.

### SUMMARY OF THE INVENTION

In one aspect, the present invention is a mobile engine lift comprising a base, rolling means supporting the base, a substantially vertical support extending from the base, and cradle means connected to the vertical support for receiving an engine. The base may be generally T-, Y- or H-shaped, or of any other convenient shape. The base may comprise or define a receptacle for receiving a ballast material to enhance the stability of the apparatus. The rolling means may be wheels or casters.

In the preferred embodiment, the cradle means comprises an arm assembly having at least two arms extending laterally outward from the vertical support, and at least two cradles, each cradle being attached to a corresponding one of the arms. The arm assembly may have adjustable cradle separation means, which may comprise an opposite-threaded bolt; i.e., wherein one cradle engages a clockwise-threaded portion of the bold and one cradle engages a counterclockwise-threaded portion, such that rotation of the bolt causes the cradles to move either away from or toward each other.

The vertical support means may have extension means for adjusting the height of the cradle means. The extension means may be operable by hydraulic means or by a motor, which will preferably but not necessarily be battery-powered.

In other embodiments, each cradle may be attached to its corresponding arm by pivot means, which may be a ball bushing. As used herein, the term “ball bushing” means a spherical plain bearing. The pivot means should have locking means for unlockably securing the cradle in a desired position. The inside surface of each cradle may have a non-slip lining such as rubber or a synthetic material. The cradles may be fashioned in any of a variety of shapes, including but not limited to trapezoidal (as illustrated in the Figures) or concave.

Other aspects of the invention will be appreciated by reference to the description of the preferred embodiment which follows, and to the claims.

### BRIEF DESCRIPTION OF THE DRAWINGS

The invention will now be described with reference to the preferred embodiment and the accompanying figures, in which numerical references denote like parts, and in which:

FIG. 1 is a perspective view of the mobile engine lift apparatus according to the invention;

FIG. 2 is a plan view of the mobile engine lift apparatus according to the invention.

FIG. 3 is a side elevation view of the mobile engine lift apparatus in its fully retracted position; and

FIG. 4 is a front elevation view of the mobile engine lift apparatus according to the invention, depicted in an extended position holding an engine.

### DETAILED DESCRIPTION OF THE PREFERRED EMBODIMENT

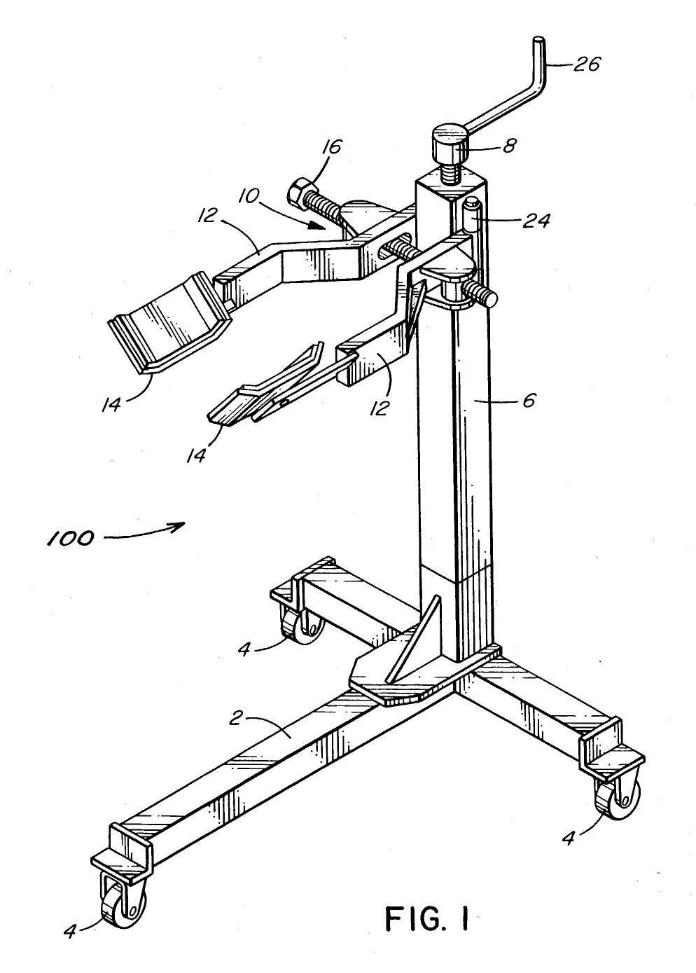

As shown in FIG. 1, the mobile engine lift apparatus of the present invention, generally indicated by reference number 100, in the preferred embodiment comprises a base 2 having rolling means 4, a substantially vertical support 6 extending from the base 2 and having extension means 8, and cradle means comprising an arm assembly 10 having a pair of arms 12 extending laterally outward from the vertical support 6, a pair of cradles 14 each attached to a corresponding one of the arms 12, and adjustable cradle separation means 16.

The base 2 may have any of a variety of shapes, including T-shaped as shown in the drawings, Y-shaped or H-shaped. The base 2 may comprise or define a receptacle (not shown) for receiving a ballast material to enhance the stability of the apparatus. The size of the base 2 and the height of the vertical support 6 may be selected as desired to suit the particular work environment in which the apparatus 100 is to be operated.

The rolling means 4 facilitates positioning of the apparatus in convenient proximity to a motorcycle removal of its engine, transport of the engine in the apparatus to a servicing location, and return of the engine to the motorcycle for reinstallation. The rolling means may comprise wheels, as shown in the Figures, or other well-known means such as casters.

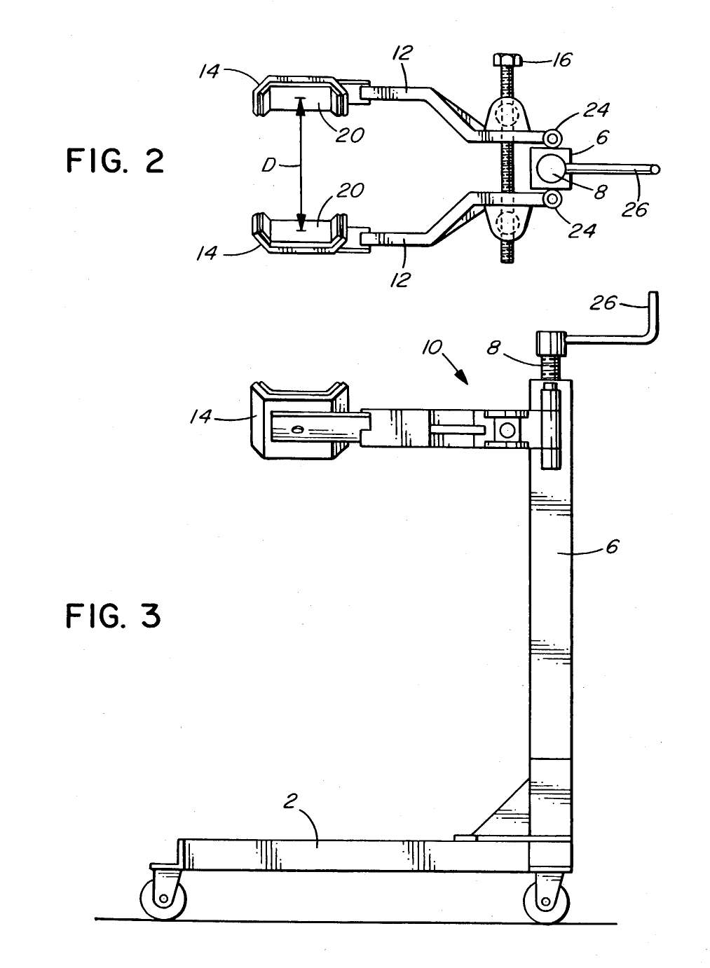

Referring now to FIG. 2, to permit use of the apparatus with a variety of engine sizes and shapes, as well as engagement of the cradles 14 at a variety of positions on an engine, the distance D between the cradles 14 may be adjusted by cradle separation means 16. In the preferred embodiment, a non-slip lining 20 is attached to the inside surface of at least one of the cradles 14, to enhance the secure engagement of an engine in the cradle means.

The adjustable cradle separation means 16 may comprise a bolt having opposite threading at each end. Turning the bolt in one direction draws the cradles 14 toward each other, while turning the bolt in the reverse direction moves the cradles 14 further apart. In this embodiment of the invention, as the distance D between the cradles 14 is adjusted, each arm 12 pivots about hinge means 24 at its point of intersection with the vertical support 6. Other cradle separation means are also possible.

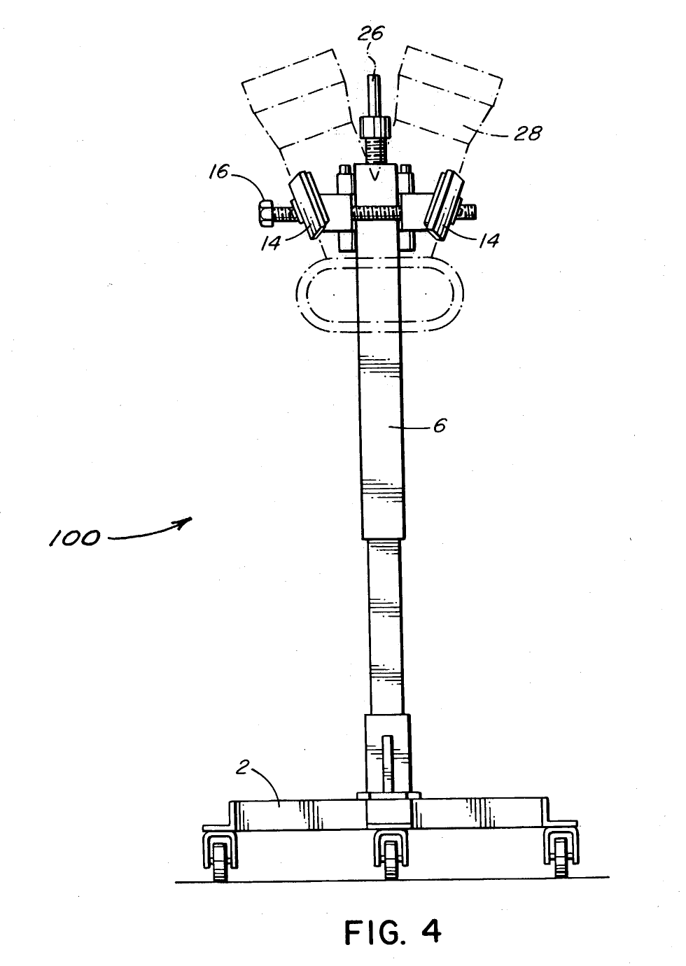

As shown in FIGS. 3 and 4, the vertical support 6 has extension means 8 to permit raising and lowering of the arm assembly 10 and cradles 14. Various means of actuating the extension means are possible, including hydraulic means, and motor means, and manual operation. In the manually-operated embodiment shown in the drawings, the extension means comprises a threaded vertical rod (not shown) operable by a crank 26, which may be rotated in one direction to lengthen the vertical support 6, thereby raising the cradle means and an engine 28 supported therein. Rotation of the crank 26 in the opposite direction shortens the vertical support 6, thereby lowering the engine 28. Where the extension means 8 is operated by an electric motor, the motor may be powered from a conventional electrical system (e.g., shop current), or it may even more conveniently be battery-powered.

Each cradle 14 may be rigidly fixed to its corresponding arm 12, or it may be pivotably attached thereto by pivot means. The pivot means preferably will comprise a ball bushing joint (not shown) allowing multi-axial pivoting about the point of connection of the cradle 14 to the arm 12. Such pivoting movement permits optimal contact of the cradle 14 with the engine. The pivotable cradle means also permits tilting of an engine held in the lift, to permit the engine to clear obstacles as it is removed from the motorcycle. Locking means (not shown) may be provided to reversibly fix the position of the cradles 14. In one embodiment, the cradle means may swivel as a unit relative to the base 2, thus enhancing the ability to manoeuver the cradles means into a desired position relative to the engine to be lifted.

In use, the engine lift apparatus according to the invention is lowered to a retracted or partially retracted position as seen in FIG. 3, moved into alignment with a motorcycle engine, and the extension means 8 are engaged to raise the arm assembly and cradles, thereby engaging, supporting, and lifting the motorcycle engine. The engine lift apparatus may then be moved to a servicing location with the engine 28 mounted therein, as depicted in FIG. 4. It will be readily appreciated that the engine may be serviced while supported in the apparatus of the present invention, or it may be transferred to another supporting means such as a workbench and later transferred back to the apparatus for reinstallation.

The materials for use in constructing the base, vertical support, arm assembly, and cradles, and the components thereof, may selected from any of several known materials including steel, aluminum, and plastic.

Although the present invention is described in the specific context of its use in association with a motorcycle engine, it will be readily appreciated that the invention may also be advantageously used with other types of mechanical equipment components in a variety of fields. To provide only one example, and without limiting the fields of its possible application, the apparatus of the present invention could be used in the removal of engines from light aircraft.

In this patent document, the word “comprising” is used in its non-limiting sense to mean that items following that word are included, but items not specifically mentioned are not excluded. A reference to an element by the indefinite article “a” does not exclude the possibility that more than one of the element is present, unless the context clearly requires that there be one and only one such element.

It will be readily seen by those skilled in the art that various modifications of the present invention may be devised without departing from the essential concept of the invention, and all such modifications are intended to be included in the scope of the claims appended hereto.

The embodiments of the invention in which an exclusive property or privilege is claimed are defined as follows:

1. A mobile engine lift apparatus comprising:
a base;
rolling means supporting the base;
a substantially vertical support extending from the base; and
cradle means connected to the vertical support.

2. The mobile engine lift apparatus of claim 1 wherein the cradle means comprises an arm assembly having at least two arms extending laterally outward from the vertical support; and at least two cradles, each cradle being attached to a corresponding one of the arms.

3. The mobile engine lift apparatus of claim 1 wherein the base comprises a receptacle for ballast.

4. The mobile engine lift apparatus of claim 1 wherein the base is generally T-shaped.

5. The mobile engine lift apparatus of claim 1 wherein the base is generally Y-shaped.

6. The mobile engine lift apparatus of claim 1 wherein the base is generally H-shaped.

7. The mobile engine lift apparatus of claim 1 wherein the rolling means comprises wheels.

8. The mobile engine lift apparatus of claim 1 wherein the rolling means comprises casters.

9. The mobile engine lift apparatus of claim 2 wherein the arm assembly further comprises adjustable cradle separation means.

10. The mobile engine lift apparatus of claim 9 wherein the adjustable cradle separation means comprises an opposite threaded bolt assembly.

11. The mobile engine lift apparatus of claim 1 wherein the vertical support further comprises extension means.

12. The mobile engine lift apparatus of claim 11 wherein the extension means comprises hydraulic extension means.

13. The mobile engine lift apparatus of claim 11 wherein the extension means comprises mechanical extension means.

14. The mobile engine lift apparatus of claim 13 wherein the mechanical extension means is operable by an electric motor.

15. The mobile engine lift apparatus of claim 14 wherein the electric motor is battery-powered.

16. The mobile engine lift apparatus of claim 2 wherein each cradle is attached to its corresponding arm by pivot means.

17. The mobile engine lift apparatus of claim 16 wherein the pivot means comprises a ball bushing joint.

18. The mobile engine lift apparatus of claim 16 wherein the pivot means further comprises locking means.

19. The mobile engine lift apparatus of claim 2 wherein at least one of the cradles has a non-slip lining on its inside surface.

20. The mobile engine lift apparatus of claim 19 wherein the non-slip lining is rubber.

21. The mobile engine lift apparatus of claim 19 wherein the non-slip lining is a synthetic material.

22. The mobile engine lift apparatus of claim 2 wherein each cradle is of a concave shape.

23. The mobile engine lift apparatus of claim 2 wherein each cradle is of a substantially trapezoidal shape.

24. The mobile engine lift apparatus of claim 1 wherein the cradle means is swivelable relative to the base.
